(19) United States
(12) Patent Application Publication
(10) Pub. No.: US 2018/0250861 A1
(43) Pub. Date: Sep. 6, 2018

(54) PEDESTAL OF MOLDING EXTRACTION MACHINE

(71) Applicant: FANUC CORPORATION, Yamanashi (JP)

(72) Inventor: Katsufumi Ohshiro, Yamanashi (JP)

(21) Appl. No.: 15/907,932

(22) Filed: Feb. 28, 2018

(30) Foreign Application Priority Data
Mar. 2, 2017 (JP) 2017-039648

(51) Int. Cl. B29C 45/42

(52) U.S. Cl. CPC B29C 45/42; B29C 2045/4241

(57) ABSTRACT

Provided is a pedestal of a molding extraction machine which may be stably carried without a particular transportation member attached thereto. In the pedestal of the molding extraction machine sorting a molded product from an injection molding machine, at least one through-hole into which a carrying member for carrying the pedestal may be inserted is provided and the carrying member such as a forklift or a hanger rod is inserted into the through-hole so that the molding extraction machine may be carried. Accordingly, there is no need to particularly attach a transportation member and the molding extraction machine may be stably carried by the carrying member.

### BACKGROUND OF THE INVENTION

### 1. Field of the Invention

The present invention relates to a pedestal and more particularly to a pedestal of a molding extraction machine for ejecting a molded product of an injection molding machine.

### 2. Description of the Related Art

An injection molding machine mainly includes a mold clamping device which opens and closes a mold to generate a mold clamping force and an injection device which melts resin and injects the melted resin into the mold, and the mold clamping device and the injection device are disposed to face each other. The resin which is injected into the mold is solidified to become a molded product and is ejected by an ejector.

The molded product which is ejected from the injection molding machine is carried by a conveyor. Then, the molded product is gripped by the molding extraction machine and is disposed in a molded product aligning tray (not illustrated) based on information from a monitoring device. In some cases, the conveyor, the monitoring device, and the molding extraction machine constitute a molded product aligning apparatus.

FIG. 4 is a diagram illustrating an example of a molded product aligning apparatus of the related art. A molded product which is molded by an injection molding machine (not illustrated) is carried by a conveyor 60 and information on the molded product is obtained by a camera 70 which is a monitoring device. Based on the information from the camera 70, the molded product is gripped by an arm 42 of a molding extraction machine 40 and is disposed in a molded product aligning tray (not illustrated). Further, the molding extraction machine 40 and the camera 70 are provided inside a cover 50.

The conveyor 60, the camera 70, the molding extraction machine 40, and the cover 50 are mounted on a pedestal 10 and are fixed to the pedestal 10 by bolts (not illustrated). Legs 12 and wheels 14 are provided at the lower portion of the pedestal 10. The legs 12 are provided in a telescopic manner and are extended when mounting the pedestal 10 to support and hold the pedestal 10 so that the pedestal does not move. When moving the pedestal 10, the legs 12 are contracted so that the wheels 14 contact a ground. When the wheels 14 are rolled in a state where the pedestal 10 is supported by the wheels 14, the pedestal 10 can move. Further, a controller (not illustrated) is provided inside the pedestal 10 and such a controller controls the molding extraction machine 40. When installing the molding extraction machine 40 on the pedestal 10, the molding extraction machine 40 and the controller inside the pedestal 10 are connected to each other by a cable (not illustrated).

Since the molding extraction machine 40 mounted on the pedestal 10 can be applied to various injection molding machines in this way, the installation location is not limited and the molding extraction machine is moved to the vicinity of various machines if necessary. In many cases, the molding extraction machine is carried by using a forklift or a crane when moving the molding extraction machine. For this reason, the molding extraction machine is carried in such a manner that the claw of the forklift is inserted into the pedestal 10 or the claw of the forklift is inserted into a dedicated transportation member provided in the pedestal so that the claw is inserted thereinto.

In the example illustrated in FIG. 4, a claw 30 of a forklift is inserted into a lower space of the pedestal 10 and the pedestal 10 and the molding extraction machine 40 are carried.

FIG. 5 is a diagram illustrating another example of a molded product aligning apparatus of the related art. The basic configurations of the pedestal 10 and the molded product aligning apparatus are similar to those of FIG. 4 and the same reference numerals are given to the same components as those of FIG. 4. A difference from FIG. 4 is that a transportation member 80 dedicated for a carrying operation is attached to the left and right lower portions of the pedestal 10. The transportation member 80 is fixed by a bolt (not illustrated) or is attached by an attachment member. Then, the claw 30 of the forklift is inserted into the transportation member 80 and the pedestal 10 and the molding extraction machine 40 are carried.

In a CD-ROM of Japanese Utility Model Application No. 4-18399 (JP 6-20398 U), there is disclosed a technology for a removable forklift holder contrived to carry the molding extraction machine by the forklift according to a configuration similar to FIG. 5.

Japanese Patent Application Laid-Open No. 1986-173884 discloses a technology of attaching a robot attachment pedestal formed as a rectangular pipe into which a claw of a forklift is inserted so as to be fixed to various attachment surfaces of a robot.

In the example illustrated in FIG. 4, the claw 30 of the forklift is inserted into the lower surface of the pedestal 10 when moving the molded product aligning apparatus. However, since a position where the claw 30 of the forklift is inserted is not provided for inserting the claw 30 of the forklift thereinto, the insertion position is provided regardless of the length or the width of the claw 30 of the forklift. As a result, there is concern that the claw 30 of the forklift inserted into the insertion position may move left and right or up and down when the molded product aligning apparatus moves. For that reason, particularly when the forklift is suddenly turned, there is concern that the insertion position of the claw 30 of the forklift may be shifted or the molded product aligning apparatus may slide out of the claw 30 of the forklift.

As for the example illustrated in FIG. 5 or the technologies disclosed in the CD-ROM of Japanese Utility Model Application No. 4-18399 (JP 6-20398 U) and the Japanese Patent Application Laid-Open No. 1986-173884, a dedicated transportation member 80 is attached to the pedestal 10, the claw 30 of the forklift is inserted thereinto, and then the apparatus moves. For that reason, there is a need to attach the dedicated transportation member 80 to the pedestal 10 when moving the molded product aligning apparatus or to secure an accommodation space when separating the transportation member 80 from the pedestal 10.

### SUMMARY OF THE INVENTION

Here, an object of the invention is to provide a pedestal of a molding extraction machine which can be stably carried without a particular transportation member attached thereto.

According to an aspect of the invention, there is provided a pedestal of a molding extraction machine for aligning and arranging a molded product from an injection molding machine, including: a first surface; and a second surface facing the first surface, in which the first surface is provided with a first hole forming member forming a first hole and the second surface is provided with a second hole forming member forming a second hole, and in which the first hole and the second hole are provided with a through-hole forming member forming at least one through-hole through which a carrying member carrying the pedestal is insertable. In the pedestal of the embodiment of the invention, since the pedestal itself is provided with at least one through-hole through which the carrying member can be inserted, there is no need to particularly attach the transportation member for inserting the carrying member thereinto. Further, since the through-hole into which the carrying member is inserted is provided, it is possible to stably carry the molding extraction machine using the carrying member.

In the pedestal of the molding extraction machine according to the above-described aspect, the through-hole formed by the through-hole forming member is provided in the vicinity of the position of the center of gravity in a height direction when the molding extraction machine is mounted on the pedestal.

In the pedestal of the molding extraction machine, since the through-hole is provided in the vicinity of the position of the center of gravity of the entire apparatus in the height direction, it is possible to more stably carry the molding extraction machine using the carrying member.

In the pedestal of the molding extraction machine according to the above-described aspect, the through-hole formed by the through-hole forming member is provided at a plurality of different positions in a height direction.

In the pedestal of the molding extraction machine, since the through-hole is provided at a plurality of different positions of the pedestal in the height direction, it is possible to more stably carry the molding extraction machine by inserting the carrying member into the through-hole best suitable for the weight and the position of the center of gravity even when the weight changes in response to the type of molding extraction machine to be mounted.

The pedestal of the molding extraction machine according to the above-described aspect further includes third and fourth surfaces orthogonal to the first and second surfaces, in which the third surface is provided with a third hole and the fourth surface is provided with a fourth hole, and in which the third hole and the fourth hole are provided with a second through-hole forming member forming a different through-hole through which the carrying member carrying the pedestal is insertable.

In the pedestal of the molding extraction machine, since another through-hole is formed in a direction orthogonal to the initial through-hole, it is possible to cope with different carrying members and to cope with a case where the carrying member cannot be inserted into the through-hole from one direction depending on the pedestal installation position by the use of the initial through-hole and another through-hole.

In the pedestal of the molding extraction machine according to the above-described aspect, the through-hole is formed as a hole into which a claw of a forklift is inserted.

In the pedestal of the molding extraction machine according to the above-described aspect, the through-hole is formed as a hole into which a hanger rod for hanging with a crane is inserted.

According to the invention, it is possible to provide a pedestal of a molding extraction machine which can be stably carried without a particular transportation member attached thereto.

### BRIEF DESCRIPTION OF THE DRAWINGS

The foregoing and other objects and features of the invention will become apparent from the following description of embodiments with reference to the accompanying drawings. In those drawings:

FIG. 1A is a side view illustrating a configuration of a molded product aligning apparatus of a first embodiment;

FIG. 1B is a perspective view illustrating the molded product aligning apparatus illustrated in FIG. 1A;

FIG. 2A is a side view illustrating a configuration of a molded product aligning apparatus of a second embodiment;

FIG. 2B is a perspective view illustrating the molded product aligning apparatus illustrated in FIG. 2A;

FIG. 3A is a side view illustrating a configuration of a molded product aligning apparatus of a modified example;

FIG. 3B is a perspective view illustrating the molded product aligning apparatus illustrated in FIG. 3A;

FIG. 4 is a diagram illustrating a configuration of a molded product aligning apparatus of the related art; and

FIG. 5 is a diagram illustrating a configuration of a molded product aligning apparatus of the related art.

### DETAILED DESCRIPTION OF THE PREFERRED EMBODIMENTS

Hereinafter, embodiments of the invention will be described with reference to the drawings.

### First Embodiment

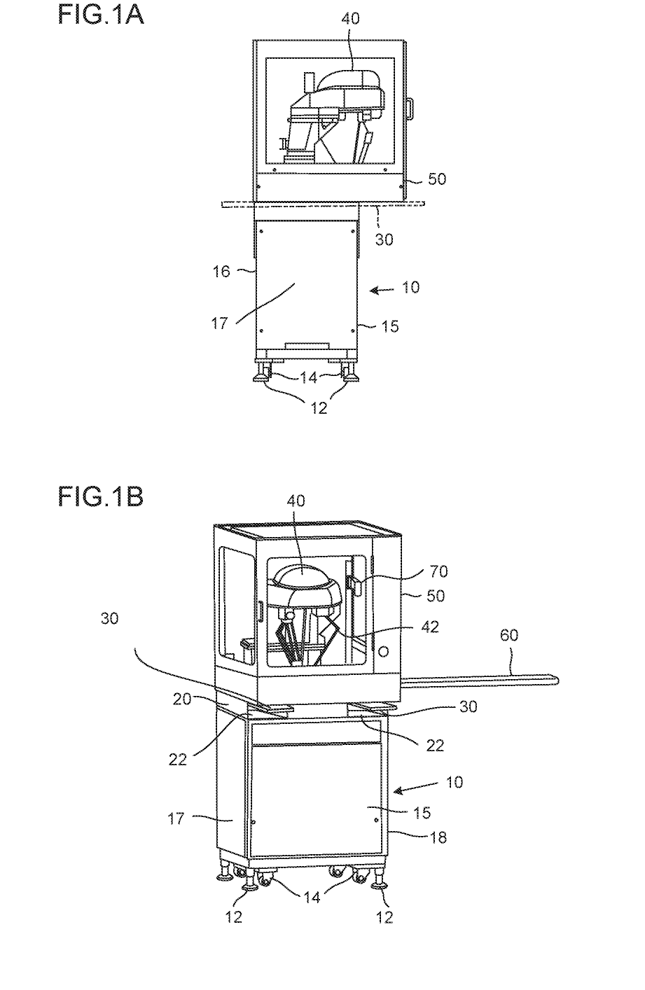

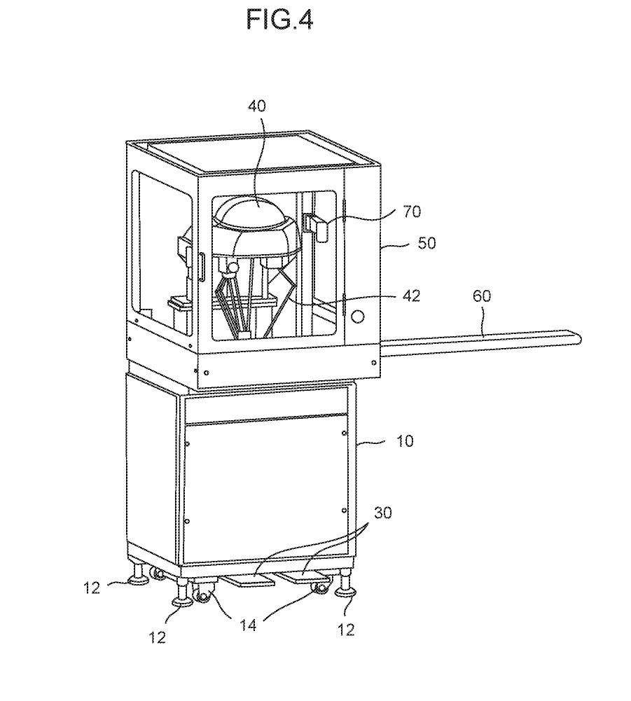

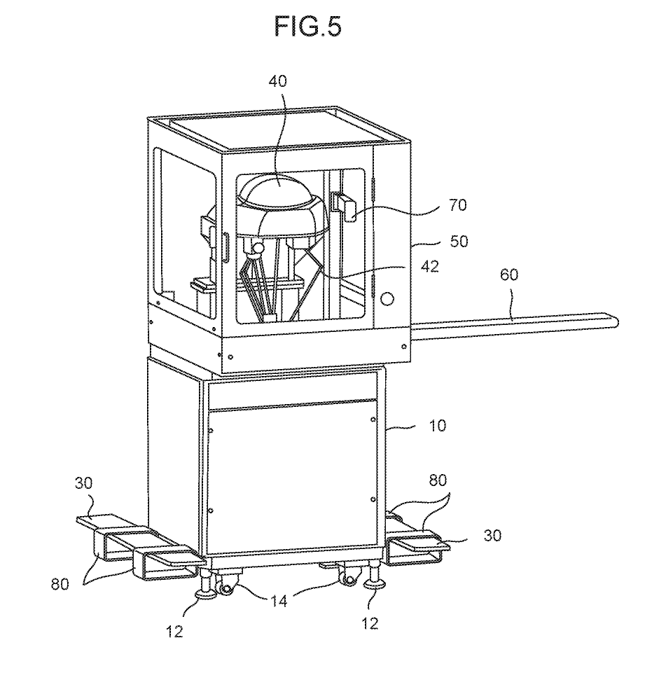

FIGS. 1A and 1B are diagrams illustrating a molded product aligning apparatus of the embodiment, where FIG. 1A illustrates a side view of the apparatus and FIG. 1B illustrates a perspective view of the apparatus. Components similar to those of the related art illustrated in FIGS. 4 and 5 will be denoted by the same reference numerals and a description thereof will be omitted.

In the embodiment, a pedestal 10 has a substantially rectangular parallelepiped shape and is formed to surround a front surface portion 15, a rear surface portion 16, a left side surface portion 17, a right side surface portion 18, and upper and lower surface portions (not illustrated). An upper portion of the pedestal 10 is provided with a carrying member insertion portion 20 and a hole is provided at two left and right positions of the front surface portion 15 and the rear surface portion 16 of the carrying member insertion portion 20 in the front view. The holes provided in the front surface portion 15 and the rear surface portion 16 are provided at the corresponding positions in the front view and a through-hole 22 is formed by the hole provided in the front surface portion 15 and the hole provided in the rear surface portion 16.

In addition, the front surface portion 15 and the rear surface portion 16 of the embodiment respectively correspond to a first surface and a second surface, the hole provided in the front surface portion 15 and its peripheral portion correspond to a first hole forming member forming a first hole, and the hole provided in the rear surface portion 16 and its peripheral portion correspond to a second hole forming member forming a second hole. Further, the carrying member insertion portion 20 which is provided with these holes corresponds to a through-hole forming member.

The through-hole 22 is formed in a square pipe shape to match the shape of a claw 30 of a forklift to be inserted thereinto and is formed to penetrate the pedestal from the front surface to the rear surface. Since the through-hole 22 is formed in a shape matching the shape of the claw 30 of the forklift, it is possible to reduce the wobble when inserting the claw 30 of the forklift into the through-hole. Further, since the through-hole 22 is formed to penetrate the pedestal from the front surface to the rear surface, the claw 30 of the forklift can be inserted into the through-hole through the pedestal 10 and thus the molding extraction machine can be stably carried.

The vertical position of the through-hole 22 is set to the vicinity of the gravity center in the height direction when the conveyor 60, the camera 70, the molding extraction machine 40, and the cover 50 are mounted on the pedestal 10. In the example illustrated in FIG. 1, since a controller (not illustrated) is assembled inside the pedestal 10, the position of the center of gravity of the entire apparatus of the molded product aligning apparatus including the pedestal 10 and the molding extraction machine 40 is near the approximate center of the height of the entire apparatus due to the weight of the controller. Since the through-hole 22 is provided in the vicinity of the position of the center of gravity of the entire apparatus in this way, the wobble generated when carrying the molding extraction machine using the carrying member is reduced and thus the molding extraction machine can be stably carried. However, in the example illustrated in FIG. 1, the through-hole is provided in the vicinity of the position of the center of gravity in the height direction at the upper portion of the pedestal 10, but the invention is not limited thereto. For example, the through-hole may be provided at another position of the lower portion.

Further, in the example illustrated in FIGS. 1A and 1B, the conveyor 60, the camera 70, the molding extraction machine 40, and the cover 50 are mounted on the pedestal 10, but only a part of them may be mounted thereon or only the molding extraction machine 40 may be mounted thereon.

In the embodiment, the through-hole 22 is formed by surrounding the periphery of the through-hole 22 using the member of the pedestal 10, but the through-hole 22 may be formed by the lower surface of the molded product aligning apparatus by attaching the molded product aligning apparatus to the pedestal 10 after removing the upper surface of the through-hole 22.

### Second Embodiment

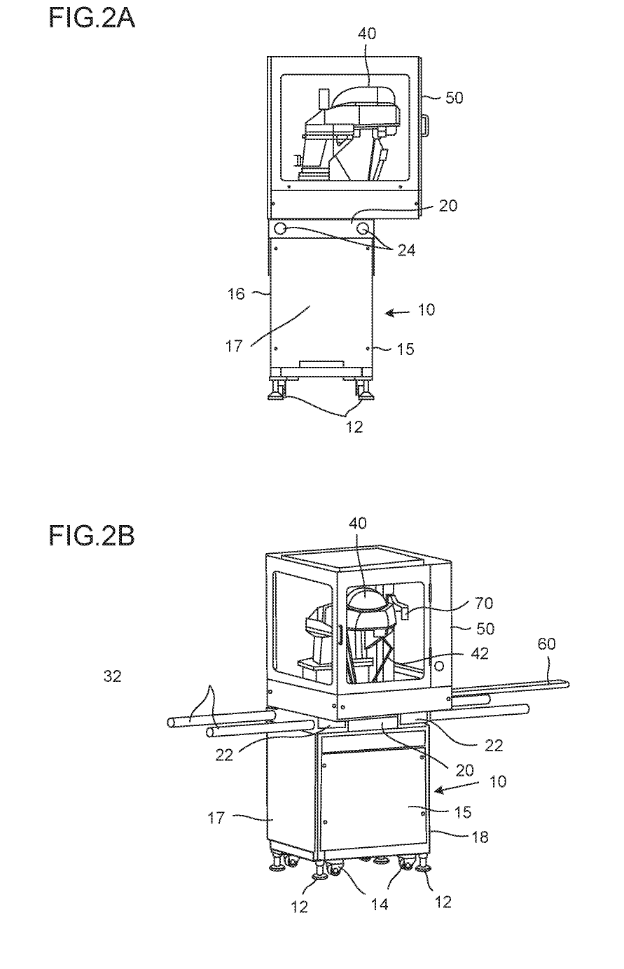

FIGS. 2A and 2B are diagrams illustrating a molded product aligning apparatus of the embodiment, where FIG. 2A is a side view of the apparatus and FIG. 2B is a perspective view of the apparatus. Also in the embodiment, the same reference numerals will be given to the same components as those of the related arts illustrated in FIGS. 4 and 5 and a description thereof will be omitted.

In the embodiment, a pedestal 10 has a substantially rectangular parallelepiped shape and is formed to surround a front surface portion 15, a rear surface portion 16, a left side surface portion 17, a right side surface portion 18, and upper and lower surface portions (not illustrated). An upper portion of the pedestal 10 is provided with a carrying member insertion portion 20 and a hole is provided at two left and right positions of the left side surface portion 17 and the right side surface portion 18 of the carrying member insertion portion 20 in the side view. The holes provided in the left side surface portion 17 and the right side surface portion 18 are provided at the corresponding positions in the side view and a through-hole 24 is formed by the hole provided in the left side surface portion 17 and the hole provided in the right side surface portion 18.

In addition, the left side surface portion 17 and the right side surface portion 18 of the embodiment respectively correspond to a first surface and a second surface, the hole provided in the left side surface portion 17 and its peripheral portion correspond to a first hole forming member forming a first hole, and the hole provided in the right side surface portion 18 and its peripheral portion correspond to a second hole forming member forming a second hole. Further, the carrying member insertion portion 20 which is provided with these holes corresponds to a through-hole forming member.

The through-hole 24 is formed in a circular shape to match a hanger rod 32 to be inserted thereinto and is formed so that the hanger rod 32 can pass therethrough. Since the through-hole 24 is formed in a hole shape matching the shape of the hanger rod 32, it is possible to reduce the wobble when inserting the hanger rod 32 into the through-hole. Further, the molding extraction machine is carried by a crane in such a manner that a wire rope for hanging the claw of the crane is caught at a position where the hanger rod 32 protrudes from the pedestal 10 when carrying the molding extraction machine. Since the hanger rod 32 is inserted into the through-hole and is caught by the claw of the crane by the rope, the molding extraction machine can be stably carried.

Similarly to the example illustrated in FIGS. 1A and 1B, the vertical position of the through-hole 24 is set to the vicinity of the center of gravity in the height direction when the conveyor 60, the camera 70, the molding extraction machine 40, and the cover 50 are mounted on the pedestal 10. Since the through-hole 24 is provided in this way, it is possible to reduce the wobble when carrying the molding extraction machine using the carrying member and to stably carry the molding extraction machine. However, the through-hole 24 may be provided at a different position in the lower portion or the like.

In the example illustrated in FIGS. 2A and 2B, the conveyor 60, the camera 70, the molding extraction machine 40, and the cover 50 are mounted on the pedestal 10, but only a part of them may be mounted thereon or only the molding extraction machine 40 may be mounted thereon.

In the example illustrated in FIGS. 2A and 2B, a hole is provided at two left and right positions of the front surface portion 15 and the rear surface portion 16 of the carrying member insertion portion 20 in the front view in addition to the through-hole 24 for inserting the hanger rod 32 thereinto.

With such a configuration, it is possible to cope with different carrying members by selecting any one of the through-holes to be used or to cope with a case where only some through-holes of the front through-hole 22 and the side through-hole 24 can be used depending on the installation position of the pedestal 10. In this case, the front surface portion 15 and the rear surface portion 16 respectively correspond to the third surface and the fourth surface.

### Modified Example

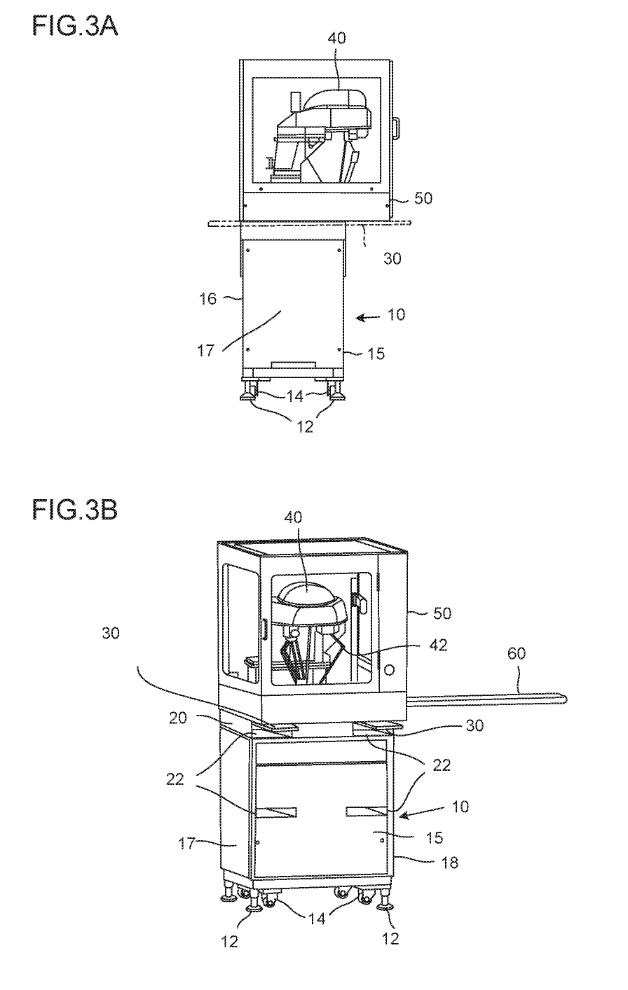

An example illustrated in FIGS. 3A and 3B is a modified example of the example illustrated in FIGS. 1A and 1B and a through-hole 22 is provided at a plurality of different positions in the height direction. Since the molding extraction machine 40 to be mounted on the pedestal 10 is generally known, it is enough to use the through-hole 22 provided at a determined position. However, in a case where the molding extraction machine 40 having a different size or weight is mounted on the pedestal, it is possible to more stably carry the molding extraction machine when the through-hole 22 is provided at a plurality of different positions in the height direction similarly to the example illustrated in FIGS. 3A and 3B and the molding extraction machine is carried by the carrying member using the through-hole 22 best suitable for the molding extraction machine 40 mounted thereon.

A modified example of the example illustrated in FIGS. 1A and 1B has been described, but the through-hole 24 for inserting the hanger rod 32 thereinto illustrated in FIGS. 2A and 2B may be provided at a plurality of different positions in the height direction.

In the description of the embodiments so far, an example in which the molded product aligning apparatus is mounted on the pedestal 10 has been described, but the pedestal may be used so that a peripheral device used for other machine tools such as an injection molding machine body and a wire electric discharge processing machine is mounted thereon.

While the embodiments of the invention have been described above, the invention is not limited to the examples of the above-described embodiments and can be implemented in other forms by appropriate modification.

1. A pedestal of a molding extraction machine for aligning and arranging a molded product from an injection molding machine, comprising:
a first surface; and
a second surface facing the first surface,
wherein the first surface is provided with a first hole forming member forming a first hole and the second surface is provided with a second hole forming member forming a second hole, and
wherein the first hole and the second hole are provided with a through-hole forming member forming at least one through-hole through which a carrying member carrying the pedestal is insertable.

2. The pedestal of the molding extraction machine according to claim 1,
wherein the through-hole formed by the through-hole forming member is provided in the vicinity of the position of the center of gravity in a height direction when the molding extraction machine is mounted on the pedestal.

3. The pedestal of the molding extraction machine according to claim 1,
wherein the through-hole formed by the through-hole forming member is provided at a plurality of different positions in a height direction.

4. The pedestal of the molding extraction machine according to claim 1, further comprising:
third and fourth surfaces orthogonal to the first and second surfaces,
wherein the third surface is provided with a third hole and the fourth surface is provided with a fourth hole, and
wherein the third hole and the fourth hole are provided with a second through-hole forming member forming a different through-hole through which the carrying member carrying the pedestal is insertable.

5. The pedestal of the molding extraction machine according to claim 1,
wherein the through-hole is formed as a hole into which a claw of a forklift is inserted.

6. The pedestal of the molding extraction machine according to claim 1,
wherein the through-hole is formed as a hole into which a hanger rod for hanging with a crane is inserted.
